(19) United States
(12) Patent Application Publication
(10) Pub. No.: US 2015/0331923 A1
(43) Pub. Date: Nov. 19, 2015

(54) CRM-BASED DATA MIGRATION SYSTEM AND METHOD

(71) Applicant: Hannda Co., Ltd., Seoul (KR)

(72) Inventor: Sun Kwon KIM, Seoul (KR)

(21) Appl. No.: 14/670,274

(22) Filed: Mar. 26, 2015

(30) Foreign Application Priority Data
May 13, 2014 (KR) 10-2014-0057063

(51) Int. Cl. G06F 17/30; G06Q 30/00

(52) U.S. Cl. CPC G06F 17/30575; G06Q 30/01

(57) ABSTRACT

Provided are a custom relationship management (CRM)-based data migration system and method. The CRM-based data migration system includes a data source determination unit configured to determine a data source to be migrated from a source database (DB), an entity selection unit configured to select an entity of a CRM DB to which the data source is to be linked, an attribute field mapping unit configured to map a first attribute field of the data source determined by the data source determination unit and a second attribute field of the entity selected by the entity selection unit to each other, and a migration performing unit configured to perform data migration from the data source to the entity, based on a mapped attribute field between the first attribute field and the second attribute field by the attribute field mapping unit. The CRM-based data migration system performs data migration as a server plug-in that executes a CRM platform event generated from a CRM software package.

### FIELD OF INVENTION

One or more embodiments of the present invention relate to a customer relationship management (CRM)-based data migration system and method, and more particularly, to a CRM-based data migration system and method capable of directly accessing a database (DB) and easily migrating desired data from the DB by determining a data source from a source DB, selecting an entity of a CRM DB to which the data source is to be linked, mapping an attribute field of the data source and an attribute field of the entity to each other, and performing data migration from the data source to the entity based on the mapped attribute fields, thereby rapidly and conveniently loading a large amount of data to the CRM DB.

### BACKGROUND OF INVENTION

Data migration refers to transferring data from at least one database (DB) to another DB. In this case, a program for processing execution files is needed since components of the other DB are different from those of the at least one DB. Thus, when data is migrated from the at least one database, the data should be converted into the same format as the other DB.

In a customer relationship management (CRM) computer software sold under the trademark Microsoft Dynamics (hereinafter “Microsoft Dynamics CRM”), for data migration for linking a large amount of data, a user needs to download an Excel file (or an XML file) that may be mapped to a target entity to his/her computer, add or change data using Excel, and upload the Excel file to a CRM DB. According to the related art, the more legacy database records present in a user's system, the higher the load on the user's manual works. Also, storing data in Excel files is limited. Furthermore, a data processing capacity of a CRM server is limited when data is uploaded.

To solve the problems of the related art, the present invention has been designed to improve a method of loading a large amount of data from a DB according to the related art and to directly access a DB so as to easily migrate desired data from the DB without converting the data into an Excel file. Also, according to the present invention, a scheduler is configured to automate a data migration process according to an automation schedule set by a user, thereby greatly improving system availability.

### SUMMARY

One or more embodiments of the present invention provide a customer relationship management (CRM)-based data migration system and method capable of directly accessing a database (DB) and migrate desired data from the DB by determining a data source from a source DB, selecting an entity of a CRM DB to which the data source is to be linked, mapping an attribute field of the data source and an attribute field of the entity to each other, and performing data migration from the data source to the entity, based on the mapped attribute fields, thereby rapidly and conveniently loading a large amount of data to the CRM DB.

Additional aspects will be set forth in part in the description which follows and, in part, will be apparent from the description, or may be learned by practice of the presented embodiments.

According to one or more embodiments of the present invention, a customer relationship management (CRM)-based data migration system includes a data source determination unit configured to determine a data source to be migrated from a source database (DB), an entity selection unit configured to select an entity of a CRM DB to which the data source is to be linked, an attribute field mapping unit configured to map an attribute field of the data source determined by the data source determination unit and an attribute field of the entity selected by the entity selection unit to each other; and a migration performing unit configured to perform data migration from the data source to the entity, based on the mapped attribute fields, wherein data migration is performed using a server plug-in that processes a CRM platform event generated from a Microsoft Dynamics CRM package while interworking with Microsoft Dynamics CRM.

The system may further include a source DB connection unit configured to receive connection information for accessing the source DB from a user and access the source DB.

The data source determination unit may determine the data source by directly receiving a structured query language (SQL) query from a user or by receiving at least one among a table, a view, and a procedure selected by the user from a list provided from a server of the source DB.

The system may further include a scheduling unit configured to set a migration schedule and transmit the set schedule to the server plug-in so as to control the migration performing unit to perform data migration according to the set schedule.

The attribute field mapping unit may selectively perform at least one of addition mapping of adding a value of the attribute field of the data source determined by the data source determination unit to the attribute field of the entity selected by the entity selection unit; modification mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same; and synchronization mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same, or adding a value of the attribute field of the data source determined by the data source determination unit to the attribute field of the entity selected by the entity selection unit when the value of the attribute field of the entity selected by the entity selection unit and the value of the attribute field of the data source determined by the data source determination unit are not the same.

According to one or more embodiments of the present invention, a customer relationship management (CRM)-based data migration method includes determining a data source to be migrated from a source database (DB), selecting an entity of a CRM DB to which the data source is to be linked; mapping an attribute field of the data source determined during the determining of the data source and an attribute field of the entity selected during the selecting of the entity to each other, and performing data migration from the data source to the entity, based on the mapped attribute fields, wherein data migration is performed using a server plug-in that processes a CRM platform event generated from a Microsoft Dynamics CRM package while interworking with Microsoft Dynamics CRM.

The method may further include receiving connection information for accessing the source DB from a user and accessing the source DB.

The determining of the data source may include determining the data source by directly receiving a structured query language (SQL) query from a user or by receiving at least one among a table, a view, and a procedure selected by the user from a list provided from a server of the source DB.

The method may further include setting a migration schedule and transmitting the set schedule to the server plug-in; and controlling data migration to be performed according to the set schedule.

The mapping of the attribute field may include selectively performing at least one of addition mapping of adding a value of the attribute field of the data source determined by the data source determination unit to the attribute field of the entity selected by the entity selection unit; modification mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same; and synchronization mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same, or adding a value of the attribute field of the data source determined by the data source determination unit to the attribute field of the entity selected by the entity selection unit when the value of the attribute field of the entity selected by the entity selection unit and the value of the attribute field of the data source determined by the data source determination unit are not the same.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic block diagram of a customer relationship management (CRM)-based data migration system according to an exemplary embodiment of the present invention;

FIG. 2 illustrates an example of connection information of a source database (DB) connection unit of a CRM-based data migration system according to an exemplary embodiment of the present invention;

FIG. 3 illustrates an example of an SQL query for a data source determination unit of a CRM-based data migration system to determine a data source according to an exemplary embodiment of the present invention;

FIG. 4 illustrates an example of a data source displayed on a preview display unit of a CRM-based data migration system according to an exemplary embodiment of the present invention;

FIG. 5 illustrate an example of an entity selected by an entity selection unit and a mapping manner performed by an attribute field mapping unit of a CRM-based data migration system according to an exemplary embodiment of the present invention;

FIG. 6 illustrates an example of a mapping process performed by an attribute field mapping unit of a CRM-based data migration system according to an exemplary embodiment of the present invention;

FIG. 7 illustrates an example of a process of setting a schedule by a scheduling unit of a CRM-based data migration system according to an exemplary embodiment of the present invention; and

FIG. 8 is a flowchart of a CRM-based data migration method according to an exemplary embodiment of the present invention.

### DETAILED DESCRIPTION

Reference will now be made in detail to embodiments of the present invention, examples of which are illustrated in the accompanying drawings, wherein like reference numerals refer to the like elements throughout the several views. In this regard, the present embodiments may have different forms and should not be construed as being limited to the descriptions set forth herein. Accordingly, the embodiments are merely described below, by referring to the figures, to explain aspects of the present description.

Terms used herein are for descriptive purposes only and are not intended to limit the scope of the invention. The terms “comprises” and/or “comprising” are used to specify the presence of stated elements, steps, operations, and/or components, but do not preclude the presence or addition of one or more other elements, steps, operations, and/or components. The terms “first,” “second,” and the like may be used to describe various elements, but do not limit the elements. Such terms are only used to distinguish one element from another. These and/or other aspects become apparent and are more readily appreciated by those of ordinary skill in the art from the following description of embodiments of the present invention, taken in conjunction with the accompanying drawings. Hereinafter, exemplary embodiments of the present invention will be described in greater detail with reference to the accompanying drawings. Here, components that are repeatedly occur or well-known functions or constructions are not described in detail if they would obscure the invention due to unnecessary detail. These embodiments are provided so that the present disclosure will be thorough and complete and will fully convey the concept of the invention to those of ordinary skill in the art. Thus, in the drawings, the shapes and sizes of layers and regions may be exaggerated for clarity.

In the present disclosure, it should be understood that the terms, such as ‘include’, ‘have,’ ‘comprise’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Also, the terms, such as ‘unit’, etc., should be understood as a unit that processes at least one function or operation and that may be embodied in hardware, software, or a combination thereof.

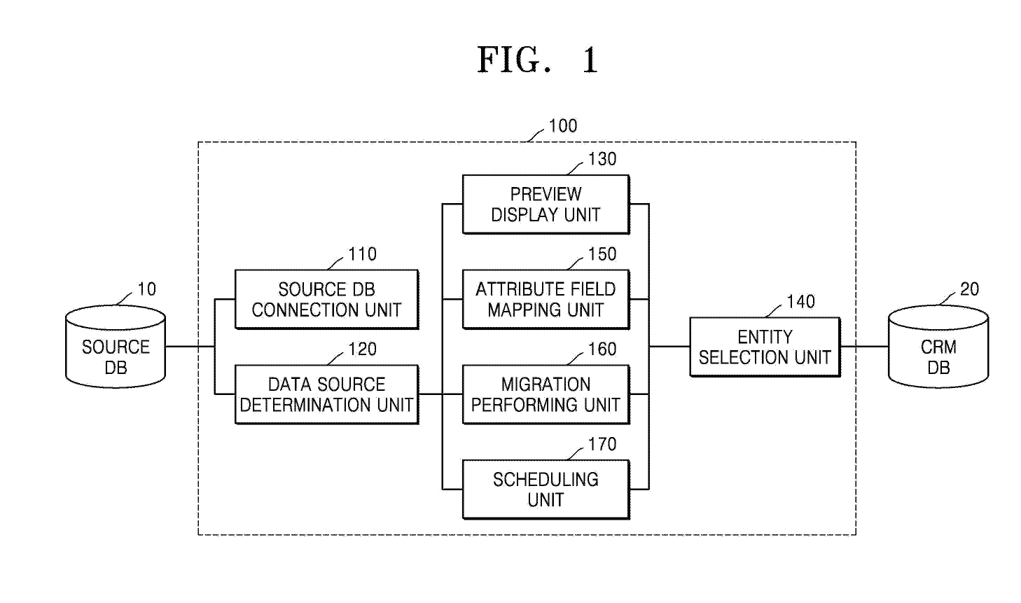

FIG. 1 is a schematic block diagram of a customer relationship management

(CRM)-based data migration system 100 according to an exemplary embodiment of the present invention.

Referring to FIG. 1, the CRM-based data migration system 100 according to an exemplary embodiment may operate while being connected to a source database (DB) 10 and a CRM DB 20. The CRM-based data migration system 100 according to an exemplary embodiment migrates a data source from the source DB 10, selects an entity of the CRM DB 20, and performs data migration to the entity from the data source.

The CRM-based data migration system 100 according to an exemplary embodiment may be embodied as a server whose clients are user terminals or embodied as being included in a server. In this case, the CRM-based data migration system 100 may be embodied as a CRM web server operating based on CRM. The CRM web server may receive signals from input units of user terminals and perform operations corresponding to the signals.

Otherwise, the CRM-based data migration system 100 according to an exemplary embodiment may be embodied as a server plug-in or as being included in a server plug-in to perform functions of components of the server plug-in. The server plug-in is a user-defined business logic process module operating in a CRM computer software package request-processing platform responding to a user's request. For instance, the CRM computer software package is sold under the trademark Microsoft Dynamics and hereinafter is referred to as Microsoft Dynamics CRM.

The server plug-in is a dynamic library code module developed mainly by CRM partner companies and designed to process a CRM platform event, such as generating data from a Microsoft Dynamics CRM package, searching for the data, modifying or deleting the data, sharing the data, etc. while interworking with Microsoft Dynamics CRM. In this case, the CRM-based data migration system 100 according to an exemplary embodiment may be provided in the form of an add-on solution on Microsoft Dynamics CRM. The developer of the add-on solution has provided this solution to create, package, and maintain a software unit for expanding Microsoft Dynamics CRM. The developer may distribute this solution so that a business function defined by the add-on solution may be installed or deleted to use Microsoft Dynamics CRM.

User terminals operating while being connected to the CRM-based data migration system 100 according to an exemplary embodiment may include an input unit for inputting various information, a display unit for displaying various information, a communication unit for transmitting and receiving various information, a control unit for processing various information, etc. For example, such user terminals may be embodied as various devices such as desktop computers, laptop computers, mobile phones, table computers, etc.

The CRM-based data migration system 100 according to an exemplary embodiment may include a source DB connection unit 110, a data source determination unit 120, a preview display unit 130, an entity selection unit 140, an attribute field mapping unit 150, a migration performing unit 160, and a scheduling unit 170. The CRM-based data migration system 100 illustrated in FIG. 1 is merely an example, and all blocks illustrated in FIG. 1 are not indispensable components. Thus, in another exemplary embodiment, some blocks may be added or some blocks may be modified or omitted.

The source DB connection unit 110 receives connection information for accessing the source DB 10 from a user and accesses the source DB 10. The connection information may include a host of the source DB 10, identification (ID) and password of the user, etc. That is, the user may register the connection information for accessing the source DB 10 beforehand to the source DB connection unit 110, and input the connection information to connect the source DB connection unit 110 to the source DB 10.

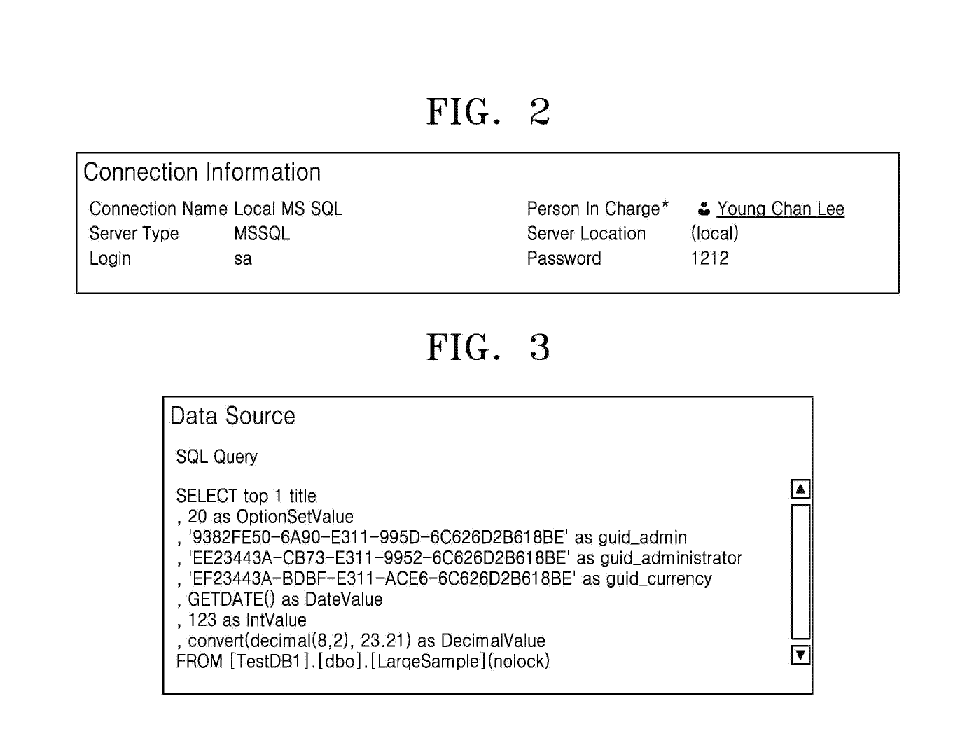

FIG. 2 illustrates an example of connection information of the source DB connection unit 110 of the CRM-based data migration system 100 according to an exemplary embodiment of the present invention.

Referring to FIG. 2, a user may register, as connection information, host information (such as a connection name, a person in charge, server type, server location, etc.) and user information (such as ID, a password, etc.), and input the connection information to access the source DB 10 via the source DB connection unit 110.

Referring back to FIG. 1, the data source determination unit 120 determines a data source to be migrated from the source DB 10. The data source determination unit 120 may determine the data source by directly receiving a structured query language (SQL) query from a user or by receiving at least one selected by the user among a table, a view, and a procedure included in a list provided from a server of the source DB 10. Thus, a user who knows the SQL query may select the data source by directly inputting the SQL query, and a user who does not know the SQL query may select the data source by selecting at least one among a table, a view, and a procedure included in the list provided from the server of the source DB 10.

FIG. 3 illustrates an example of a SQL query for the data source determination unit 120 of the CRM-based data migration system 100 to determine a data source according to an exemplary embodiment of the present invention.

Referring back to FIG. 1, the preview display unit 130 displays a preview of the data source determined by the data source determination unit 120 so that a user may view it. The data source displayed on the preview display unit 130 may be transmitted to a user's terminal so that a user may view the contents via his/her terminal. The user may check whether the data source displayed on the preview display unit 130 is correct by inputting his/her SQL query, modify the SQL query or input a new SQL query when the data source needs to be modified, and view the modified data source on the preview display unit 130.

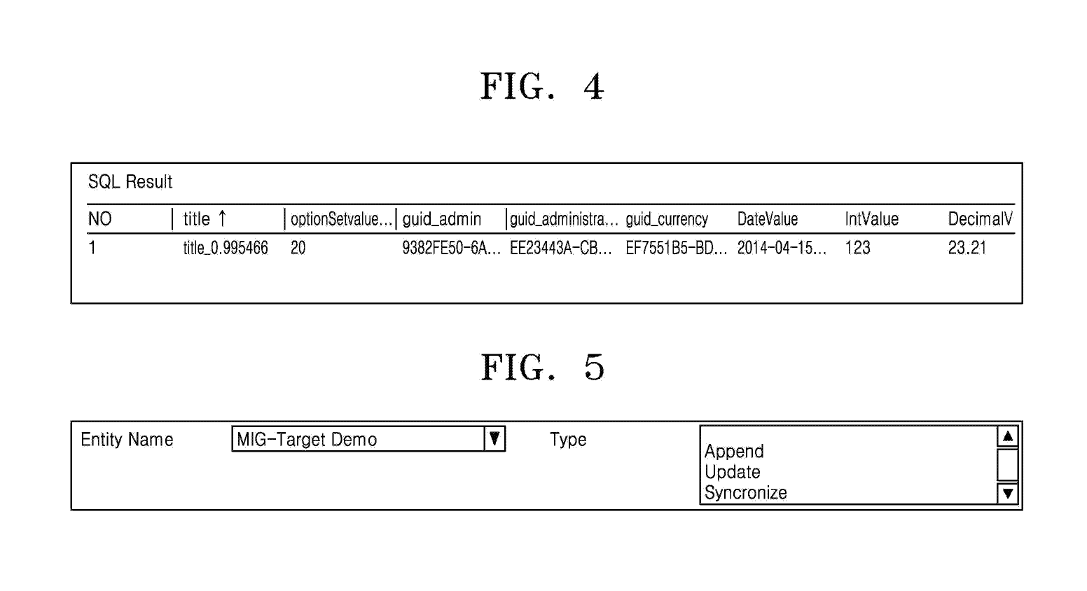

FIG. 4 illustrates an example of a data source displayed on the preview display unit 130 of the CRM-based data migration system 100 according to an exemplary embodiment of the present invention.

Referring to FIG. 4, a data source determined according to a user input is output beforehand to the preview display unit 130 so that the user may view it.

Referring back to FIG. 1, the entity selection unit 140 selects an entity of the CRM DB 20 to the data source is to be linked. The entity means an object to which data is migrated from the data source and may be selected from the CRM DB 20.

The attribute field mapping unit 150 maps an attribute field of the data source determined by the data source determination unit 120 and an attribute field of the entity selected by the entity selection unit 140 to each other. By mapping the attribute fields of the data source and the entity, attribute fields for migrating data from the data source to the entity may be selected. The attribute field mapping unit 150 may selectively perform at least one among addition mapping of adding a value of the attribute field of the data source determined by the data source determination unit to the attribute field of the entity selected by the entity selection unit; modification mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same; and synchronization mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same, or adding a value of the attribute field of the data source determined by the data source determination unit to the attribute field of the entity selected by the entity selection unit when the value of the attribute field of the entity selected by the entity selection unit and the value of the attribute field of the data source determined by the data source determination unit are not the same.

FIG. 5 illustrate an example of an entity selected by the entity selection unit 140 and a mapping manner performed by the attribute field mapping unit 150 of the CRM-based data migration system 100 according to an exemplary embodiment of the present invention.

Referring to FIG. 5, the entity selection unit 140 and the attribute field mapping unit 150 may select an entity which will be a mapping target from a list and determine at least one among addition mapping, modification mapping, and synchronization mapping as a mapping manner according to a user input.

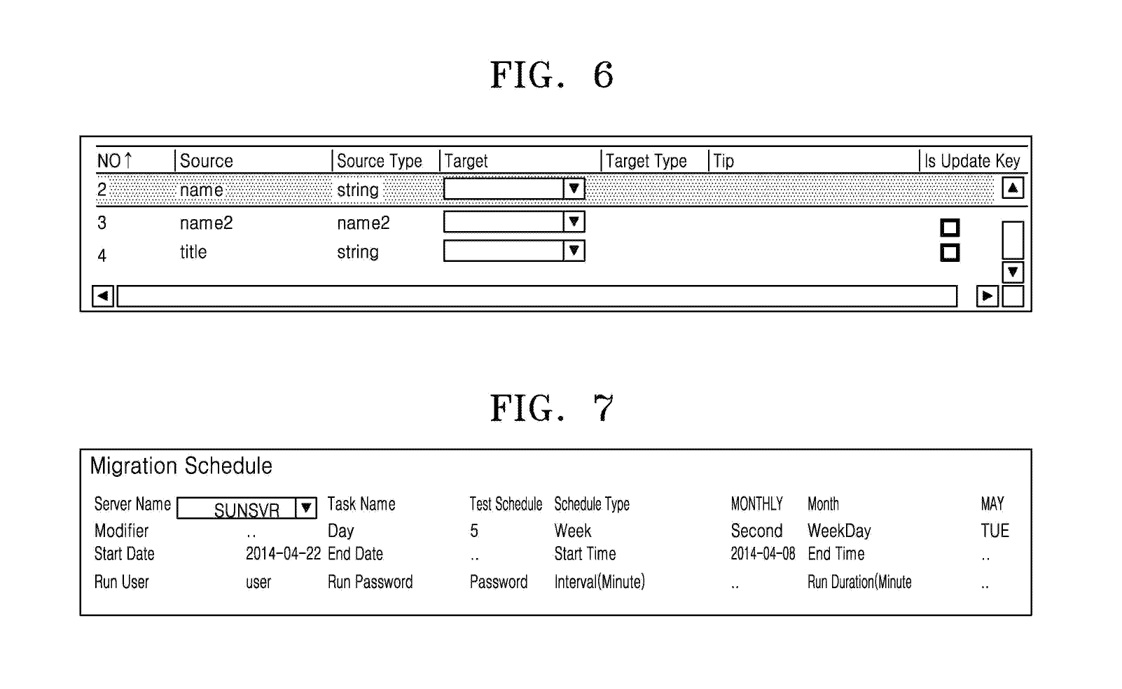

FIG. 6 illustrates an example of a mapping process performed by the attribute field mapping unit 150 of the CRM-based data migration system 100 according to an exemplary embodiment of the present invention.

Referring to FIG. 6, after a data source is input, the attribute field mapping unit 150 may automatically output attribute fields corresponding to the data source, select attribute fields corresponding to an entity (which is designated according to a user input) from a selection box, and determine a mapping manner. When a mapping manner is modification mapping or synchronization mapping, whether information of a target field is to be used as a key value may be input through an ‘Is Update Key’ item on a right portion of the selection box. Here, when information of a field is set as a key value, the information of the field may be searched for as a key value and modified in the case of modification mapping or synchronization mapping.

Referring back to FIG. 1, the migration performing unit 160 performs data migration from the data source to the entity based on the mapped attribute fields. Data migration should be understood as migrating data from the data source of the source DB 10 to the entity of the CRM DB 20 according to the attribute fields mapped by the attribute field mapping unit 150. The migration performing unit 160 may perform data migration when a ‘migrate’ button displayed on a user terminal is clicked.

The scheduling unit 170 sets a migration schedule and transmits the set schedule to the server plug-in so as to control the migration performing unit 160 to perform data migration according to the set schedule. When data migration is to be automated according to a user's demand, the scheduling unit 170 may set a predetermined period during which data migration is automatically performed. For example, a user may set a time period, e.g., in a unit of minute, hour, day, week, month, etc., and set data migration to be performed whenever the time period elapses. The scheduling unit 170 may receive a schedule set by a user and control the migration performing unit 160 to perform data migration according to the set schedule.

The scheduling unit 170 may reserve a data migration job by receiving windows execution security authentication information for server control and execution from a user, and transmitting schedule information to a windows job scheduler of a server that will actually operate or another scheduler program or setting schedule information by impersonating a security account corresponding to the windows execution security authentication information, so that the migration performing unit 160 may be controlled to perform data migration.

FIG. 7 illustrates an example of a process of setting a schedule by the scheduling unit 170 of the CRM-based data migration system 100 according to an exemplary embodiment of the present invention.

Referring to FIG. 7, the scheduling unit 170 may receive a user input and set schedule information to reserve data migration. First, a server that will control data migration according to a schedule may be selected from a server list. Then, schedule information may be set by set task name, schedule type, a time period in a unit of month, day, and time, etc.

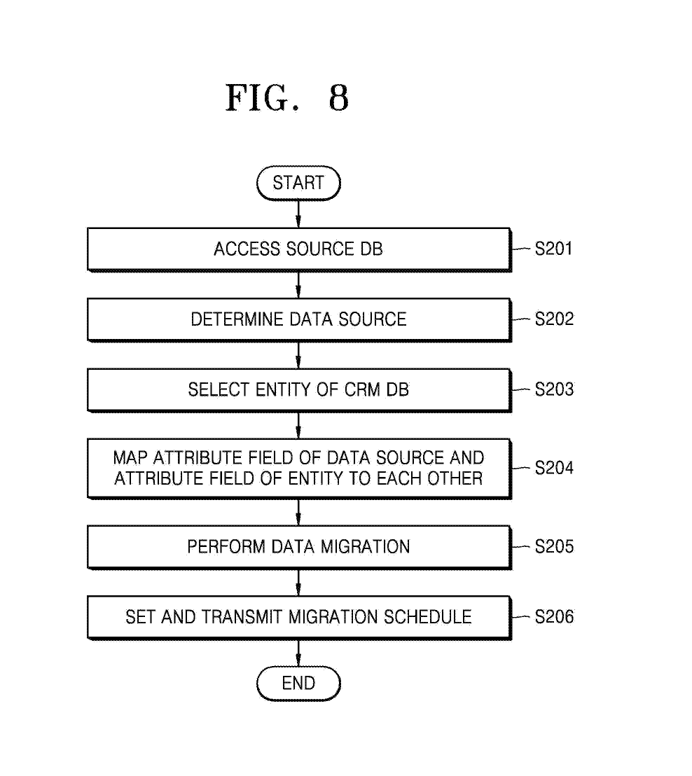

FIG. 8 is a flowchart of a CRM-based data migration method according to an exemplary embodiment of the present invention.

Referring to FIG. 8, first, when a CRM-based data migration method according to an exemplary embodiment starts, a source DB is accessed by receiving connection information for accessing the source DB from a user (operation S201), and a data source that is to be migrated from the source DB is determined (operation S202). In operation S202, the data source may be determined by directly receiving a SQL query from the user or by receiving at least one among a table, a view, and a procedure selected by the user from a list provided from a server of the source DB.

Then, an entity of a CRM DB to which the data source is to be linked is selected (operation S203), and an attribute field of the data source determined in operation S202 and an attribute field of the entity selected in operation S203 are mapped to each other (operation S204). In operation S204, at least one among addition mapping of adding a value of the attribute field of the data source determined by the data source determination unit to the attribute field of the entity selected in operation S203; modification mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same; and synchronization mapping of modifying a value of an attribute field of an entity, except for an existing attribute field which is set as a key value, to a value of the attribute field of the data source determined by the data source determination unit when the value of the attribute field of the entity selected by the entity selection unit and the value of the attribute field of the data source determined by the data source determination unit are the same, or adding a value of the attribute field of the data source determined by the data source determination unit to the attribute field of the entity selected in operation S203 when the value of the attribute field of the entity selected by the entity selection unit and the value of the attribute field of the data source determined by the data source determination unit are not the same.

Then, data migration is performed from the data source to the entity, based on the mapped attribute fields (operation S205). Then, a migration schedule is set and transmitted to a server plug-in so that data migration may be performed according to the set migration schedule in operation S205 (operation S206).

In the CRM-based data migration method of FIG. 8, CRM-based data migration is performed in a manner similar to the manner in which CRM-based data migration is performed by the CRM-based data migration system 100 of FIG. 1. Thus, unless mentioned otherwise, the description of FIG. 1 also applies to FIG. 8 and thus CRM-based data migration is not described here in detail. Similar to FIG. 1, all operations S201 to S206 of the CRM-based data migration method FIG. 8 are not indispensable and thus other operations may be added or some of these operations may be modified or omitted in another exemplary embodiment.

As described above, a CRM-based data migration system and method according to an embodiment of the present invention are capable of directly accessing a DB to easily obtain desired data from the DB by determining a data source from a source DB, selecting an entity of a CRM DB to which the data source is to be linked, mapping an attribute field of the data source and an attribute field of the entity to each other, and performing data migration to the entity from the data source based on the mapped attribute fields. Accordingly, a large amount of data may be rapidly and conveniently loaded to the CRM DB.

Also, with a CRM-based data migration system and method according to an embodiment of the present invention, a large amount of data may be loaded to a CRM DB at a high speed and conveniently.

Also, with a CRM-based data migration system and method according to an embodiment of the present invention, a user may conveniently set up and mange a scheduler-based automated data link system without development and services provided by CRM Partner and management and repair, thereby minimizing costs for system management.

While one or more embodiments of the present invention have been illustrated and described above, the technical idea of the present invention is not limited to the accompanying drawings and the above description. It will be obvious to those of ordinary skill in the art that various changes in form and details may be made therein without departing from the spirit and scope of the present invention as defined by the following claims.

What is claimed is:

1. A customer relationship management (CRM)-based data migration system comprising:
a data source determination unit configured to determine a data source to be migrated from a source database (DB);
an entity selection unit configured to select an entity of a CRM DB to which the data source is to be linked;
an attribute field mapping unit configured to map a first attribute field of the data source determined by the data source determination unit and a second attribute field of the entity selected by the entity selection unit to each other; and
a migration performing unit configured to perform data migration from the data source to the entity, based on a mapped attribute field between the first attribute field and the second attribute field by the attribute field mapping unit,
wherein the CRM-based data migration system performs data migration as a server plug-in that executes a CRM platform event generated from a CRM software package.

2. The system of claim 1, further comprising a source DB connection unit configured to receive connection information for accessing the source DB from a user and to access the source DB.

3. The system of claim 1, wherein the data source determination unit determines the data source by directly receiving a structured query language (SQL) query from a user or by receiving at least one among a table, a view, and a procedure selected by the user from a list provided from a server of the source DB.

4. The system of claim 1, further comprising a scheduling unit configured to set a migration schedule and to transmit the set schedule to the server plug-in so as to control the migration performing unit to perform data migration according to the set schedule.

5. The system of claim 1, wherein the attribute field mapping unit selectively performs at least one of:
addition mapping of adding a value of the first attribute field of the data source determined by the data source determination unit to the second attribute field of the entity selected by the entity selection unit;
modification mapping of modifying a value of an attribute field of the entity, except for an existing attribute field which is set as a key value, to a value of the first attribute field of the data source determined by the data source determination unit when the value of the second attribute field of the entity selected by the entity selection unit and the value of the first attribute field of the data source determined by the data source determination unit are the same; and
synchronization mapping of modifying a value of the attribute field of the entity, except for an existing attribute field which is set as a key value, to a value of the first attribute field of the data source determined by the data source determination unit when the value of the second attribute field of the entity selected by the entity selection unit and the value of the first attribute field of the data source determined by the data source determination unit are the same, or adding a value of the first attribute field of the data source determined by the data source determination unit to the second attribute field of the entity selected by the entity selection unit when the value of the second attribute field of the entity selected by the entity selection unit and the value of the first attribute field of the data source determined by the data source determination unit are not the same.

6. A customer relationship management (CRM)-based data migration method comprising:
determining a data source to be migrated from a source database (DB);
selecting an entity of a CRM DB to which the data source is to be linked;
mapping a first attribute field of the data source determined during the determining of the data source and a second attribute field of the entity selected during the selecting of the entity to each other; and
performing data migration from the data source to the entity, based on a mapped attribute field between the first attribute field and the second attribute field by the attribute field mapping unit,
wherein the CRM-based data migration system performs data migration as a server plug-in that executes a CRM platform event generated from a CRM software package.

7. The method of claim 6, further comprising receiving connection information for accessing the source DB from a user and accessing the source DB.

8. The method of claim 6, wherein the determining of the data source comprises determining the data source by directly receiving a structured query language (SQL) query from a user or by receiving at least one among a table, a view, and a procedure selected by the user from a list provided from a server of the source DB.

9. The method of claim 6, further comprising:
setting a migration schedule and transmitting the set schedule to the server plug-in; and
controlling data migration to be performed according to the set schedule.

10. The method of claim 6, wherein the mapping of the attribute field comprises selectively performing for the entity selected during the selecting of the entity at least one of:
addition mapping of adding a value of the first attribute field of the data source determined by the data source determination unit to the second attribute field of the entity selected by the entity selection unit;
modification mapping of modifying a value of an attribute field of the entity, except for an existing attribute field which is set as a key value, to a value of the first attribute field of the data source determined by the data source determination unit when the value of the second attribute field of the entity selected by the entity selection unit and the value of the first attribute field of the data source determined by the data source determination unit are the same; and
synchronization mapping of modifying the value of the attribute field of the entity, except for an existing attribute field which is set as a key value, to a value of the first attribute field of the data source determined by the data source determination unit when the value of the second attribute field of the entity selected by the entity selection unit and the value of the first attribute field of the data source determined by the data source determination unit are the same, or adding the value of the first attribute field of the data source determined by the data source determination unit to the second attribute field of the entity selected by the entity selection unit when the value of the second attribute field of the entity selected by the entity selection unit and the value of the first attribute field of the data source determined by the data source determination unit are not the same.
